(19) United States
(12) Patent Application Publication
(10) Pub. No.: US 2012/0298731 A1
(43) Pub. Date: Nov. 29, 2012

(54) CARTON AND METHOD OF MANUFACTURE THEREOF

(75) Inventors: David Hargreaves, Lancashire (GB); Colin Hargreaves, Lancashire (GB); Brian Jones, Lancashire (GB)

(73) Assignee: EMERSON & RENWICK LTD, Lancashire (GB)

(21) Appl. No.: 13/514,767

(22) PCT Filed: Dec. 8, 2010
(86) PCT No.: PCT/GB2010/052044

§ 371 Date: Aug. 7, 2012

(30) Foreign Application Priority Data
Dec. 9, 2009 (GB) 0921572.4
Jun. 13, 2010 (GB) 1007975.4

(51) Int. Cl. B31B 3/00; B65D 5/00; B65D 3/00

(52) U.S. Cl. 229/100; 493/52; 229/400

(57) ABSTRACT

A method of forming a carton including a sleeve member is disclosed. The method includes the steps of locating a sleeve member blank in registration with a carton body blank in a pre-determined position, and attaching an inner surface of the sleeve member blank to an external surface of the carton body blank prior to forming and/or erecting the attached carton and sleeve blanks into a required erect carton shape.

This invention relates to a carton and method of manufacture thereof, and particularly although not necessarily exclusively to a carton in the form of a cup.

Although the following description refers to a cup in the form of a drinks cup, typically for the containment of a hot liquid or beverage, it will be appreciated by persons skilled in the art that the carton of the present invention can be for use in any application and can be any suitable size, shape and/or design of container.

It is well known to provide paper cups for the containment of beverages, particularly in the take-away or fast food industry. If the beverage is a hot beverage, such as for example tea, coffee or hot chocolate, it is also known to provide an insulating type of sleeve member around the external surface of the paper cup, to prevent a user from burning themselves when gripping the outside of the cup. The cup typically has the shape of a frustum of a cone which tapers outwardly from a base of the cup towards an open top thereof. The upper edge of the cup defining the open top is often provided with a rolled lip thereon to provide a neat edge from which a user can drink. The sleeve member is typically of a substantially complementary shape to the external side walls of the cup body and is normally formed from corrugated paper or board material. The corrugations in the paper or board material allow air to be trapped in regions between the corrugations to provide the insulating effect of the sleeve member. The sleeve member is typically fitted around the external side walls of the cup body once the cup has been formed.

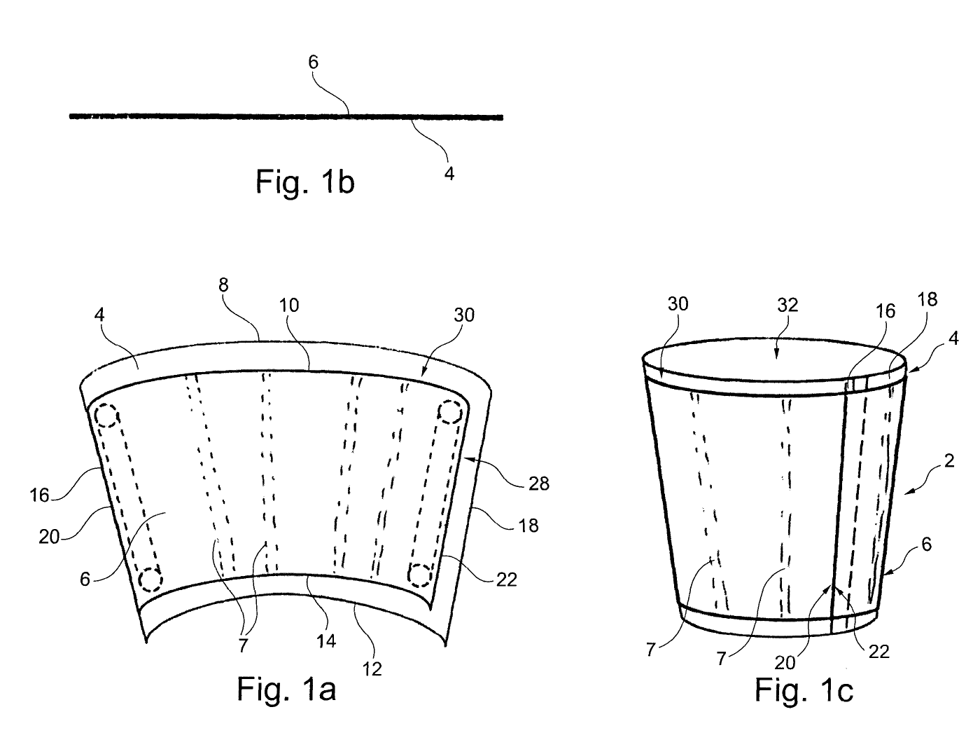

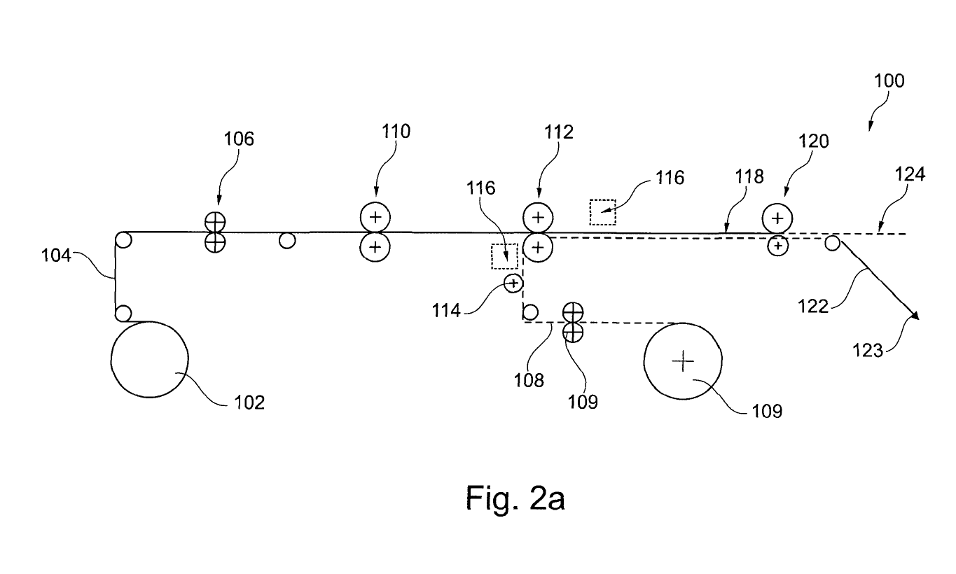

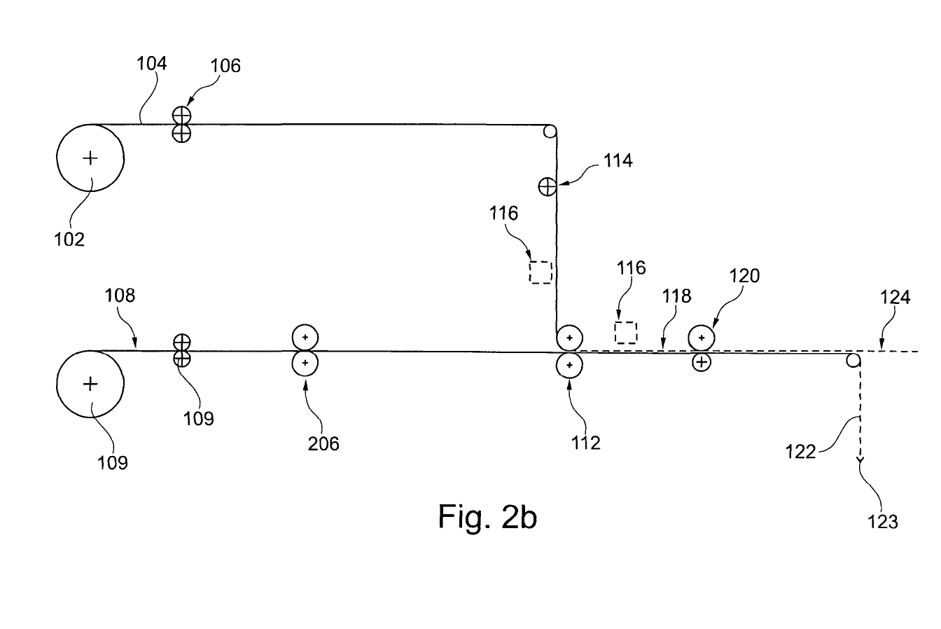

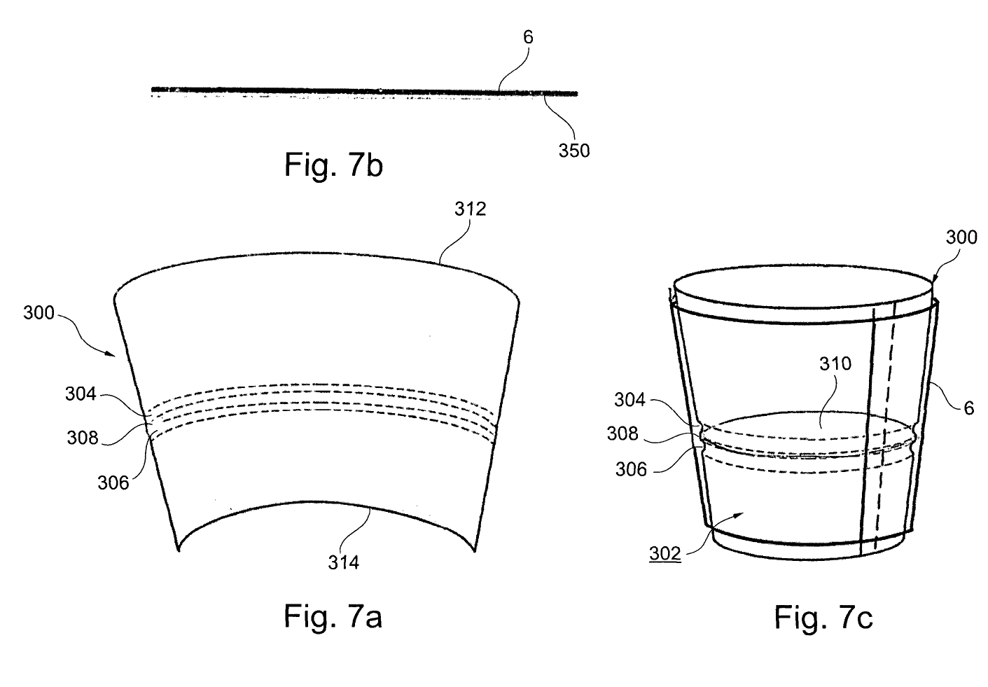

An example of a conventional corrugated sleeve member comprises at least two separate layers; an outer facing corrugated layer with an inner facing backing layer attached thereto, as shown in FIGS. 1 and 2 of AU2006230694. The inner facing backing layer can be used to attach the corrugated outer layer or layers to the cup body. Alternatively, the corrugated sleeve member can comprise a single corrugated layer, as shown in FIG. 3-8 of AU2006230694 as an example. The sleeve member is then located around the formed cup body and glued in position.

Problems associated with the existing cup and insulating sleeve member arrangements are that the production of the cup requires at least two separate manufacturing processes; manufacturing of the cup body and then application of the sleeve around the exterior of the formed cup body. This increases both the time and expense associated with producing the cup. The use of a sleeve member comprising a corrugated or embossed layer and a backing layer also increases the cost of manufacturing the cup. However, a problem associated with using a single embossed layer is that the profile often becomes flattened or damaged as a result of having no supporting backing layer associated therewith.

It is therefore an aim of the present invention to overcome the abovementioned problems and to provide an improved carton or cup.

It is a further aim of the present invention to provide a method of manufacturing an improved carton or cup.

According to a first aspect of the present invention there is provided a method of forming a carton including a sleeve member, said method including the steps of locating a sleeve member blank in registration with a carton body blank in a pre-determined position, and attaching an inner surface of the sleeve member blank to an external surface of the carton body blank prior to forming and/or erecting the attached carton and sleeve blanks into a required erect carton shape.

In one embodiment the carton is in the form of a cup but could be in the form of any suitable box, container and/or the like and could be any suitable size, shape and/or design, such as square, rectangular, tubular, conical and/or the like.

The pre-determined position of the sleeve member blank on the carton body blank typically depends on the shape and/or design of the carton but is preferably in such a position to allow a user to grip the sleeve member when the carton is an erect form.

According to a further aspect of the present invention there is provided a method of forming a cup, said method including the steps of locating a sleeve member blank in registration with a cup body blank in a pre-determined position and attaching an inner surface of the sleeve member blank to an external surface of the cup body blank prior to forming and/or erecting the attached cup and sleeve blanks into a required erect cup shape.

By attaching the sleeve member blank to the carton or cup member blank when both elements are pre-formed/pre-erected, this allows formation of the final carton or cup/sleeve blank in fewer stages, and preferably in a single stage, and ensures more accurate registration of the sleeve with the carton or cup body in the required position.

Preferably the method includes the step of embossing the sleeve member blank and/or the carton or cup body blank prior to erection of the carton or cup. The embossing step can include the location of or formation of any or any combination of one or more ridges and/or grooves, corrugations, logos, patterns, profiles, designs, images, shapes, letters, numerals and/or the like in the sleeve member material and/or the carton or cup body material using embossing means. The embossing step preferably typically takes place before the sleeve member blank is attached to the carton or cup body blank.

Embossment of the cup, carton and/or sleeve member blank can provide an air gap between the cup or carton and sleeve member blanks when joined so as to provide insulation means if the formed cup or carton is used to hold hot or cold liquids. In addition to or alternatively, embossment on a surface of the cup or carton can be used to provide location means for the location of a foil, closure means, membrane, other item and/or the like therewith. A foil, closure means or membrane can be used to create a substantially closed compartment or sub-compartment within the cup or carton to allow one or more items or product to be retained therein.

The embossing means can include any suitable means, such as for example embossment rollers and/or the like.

Preferably the sleeve member blank material and/or carton or cup body blank material comprises a single layer of material or a laminate material (multi-ply material). Preferably the material is embossed. In either embodiment at least part of the rear surface of the embossed material is attached directly to the outer surface of the carton or cup body (i.e. there is no requirement for an intermediate backing layer); and/or the front surface of the embossed carton or cup member material is attached directly to the rear surface of the sleeve member material. Formation of the sleeve member blank from a single embossed layer or single embossed laminate material layer and joining the same to the carton or cup body blank prior to forming the carton or cup body reduces costs associated with having to provide the sleeve member with a backing layer to support any corrugation or embossment provided thereon. This advantage also applies where the carton or cup body blank is formed from a single embossed layer or single embossed laminate material layer and joining the same to a sleeve member blank prior to erection of the finished carton or cup.

Embossment of the sleeve member blank or material and/or the carton or cup body blank or material and attaching the carton or cup body blank or material to the sleeve member blank typically takes place in a single piece of apparatus, such as for example a single line apparatus. Thus, the embossment process takes place upstream of the blank attachment process in the apparatus and prevents or limits collapsing or damage of the embossment on the sleeve member blank and/or carton or cup body blank prior to attaching the two blanks together.

Preferably registration means are associated with the carton or cup body blank, the sleeve member blank and/or on an elongate web of material from which the carton or cup body blank and/or sleeve member blank are formed to allow the two blanks to be brought into registration or correct alignment together prior to and/or during attachment of the two blanks together. It can also ensure an embossment introduced onto the sleeve member blank and/or carton or cup body blank in an embossment step is in the correct position on the blank. This is of particular importance if the sleeve member blank and/or carton or cup body blank is pre-printed and the embossment is required to be in a particular location with respect to the pre-printed matter on the sleeve member blank and/or carton or cup body blank. Furthermore, it can ensure that attachment means associated with the blank(s) are provided in the correct location (for example, to ensure adhesive is located in the correct position on the blank(s)).

It will be appreciated that reference to registration or attachment of the sleeve member blank or carton or cup body blank also covers the registration or attachment of web material from which the blanks are formed.

The registration means can include any or any combination of a suitable mark, cut and/or indication means on the blank(s) or web material from which the blank(s) is formed.

Preferably each of the sleeve member blank and cup or carton body blank have registration means provided thereon and the two registration means of each pair of blanks (i.e. a sleeve member and carton or cup body blank pair) have to be aligned or brought into registration. Preferably registration of the registration means is achieved using registration apparatus. The registration means allows the correct pre-determined position of the sleeve member blank on the carton or cup body blank to be formed.

The registration means are preferably substantially hidden from view of a user when the final cup or carton is formed and the user views at least the exterior of the carton or cup. For example, the registration means can be provided on a seam or edge of the carton or cup body or sleeve member and/or can be provided in the surrounding web material from which the carton or cup body or sleeve member blank are formed and later discarded once the blanks have been attached together.

Detection of the registration means prior to, during and/or after the embossing step, gluing step an/or blank attachment/lamination step can be via any conventional detection means, such as for example, manually, using camera or imaging technology, sensing technology and/or the like. The detection means can be located at any suitable position in the apparatus and are preferably arranged at the point just prior to attaching or laminating the sleeve member blank with the carton or cup body blank.

Preferably the sleeve member blank and/or the carton or cup body blank are formed from elongate webs of material. The sleeve member blank and/or carton or cup body blank can be brought into registration and attached to each other before or after the blank is cut from the elongate webs of material. The material webs or blanks can be fed into the carton forming apparatus using suitable means, such as feed rollers and/or the like.

In one embodiment at least one of the material web(s) or blank(s) are fed into the apparatus using a braked unwind roller, preferably having lateral web guidance and/or loadcell feedback tension control.

Preferably the registration apparatus is or includes tensioning means associated with either the sleeve member feeding part of the carton forming apparatus and/or the carton or cup body feeding part of the apparatus to allow the sleeve member and carton or cup body material to be joined together at the correct material tension to allow correct registration or alignment of the registration means when the webs of material or blanks are joined.

Preferably the tensioning means is in the form of a tensioning nip, roller, rollers and/or the like. The tensioning means can be controlled by suitable control means to allow adjustment of the tension of the blank material, web material and/or the like at a suitable location in the apparatus.

In one embodiment the tensioning means or registration apparatus are provided between the input feed of the sleeve member material into the carton forming apparatus and the embossing means for the sleeve member. This ensures the embossment takes place in the correct location on the sleeve member material or blank. This is of particular importance, although not necessarily essential, if the sleeve member is pre-printed and the embossment needs to be made in a particular position on the sleeve member blank relative to the pre-printed matter.

In one embodiment the registration apparatus or tensioning means or registration apparatus are provided between the input feed of the carton or cup body material into the apparatus and the embossing means for the carton or cup body. This ensures the embossment takes place in the correct location on the carton or cup body material or blank. This is of particular importance, although not necessarily essential, if the carton or cup body blank and/or sleeve member is pre-printed and the embossment needs to be made in a particular position on the carton or cup body blank relative to the pre-printed matter.

In one embodiment the tensioning means takes place or is provided upstream in the apparatus of the location of the carton or cup body feeding input and/or the attachment means for attaching the sleeve member blank and the carton or cup body blank together.

In one embodiment the tensioning means takes place or is provided upstream in the apparatus of the location of the sleeve member feeding input and/or the attachment means for attaching the sleeve member blank and the carton or cup body blank together.

The same tensioning means or additional tensioning means or registration apparatus can be used to ensure correct registration of an adhesive or gluing step for the sleeve member (i.e. to ensure the adhesive or glue is applied in the correct location) and/or carton or cup body.

In one embodiment the embossment and attachment means are operated together in substantial synchrony. This can be as a result of the embossment and attachment means being locked together electronically so adjustment of the same is undertaken substantially simultaneously or synchronously.

In one embodiment tensioning means or registration apparatus are provided between the input feed of the carton or cup body material into the apparatus and the gluing and/or lamination means of the apparatus. This ensures the carton or cup body material is in the correct position for registration, particularly if the carton or cup body material is pre-printed.

In one example two sets of tensioning means or registration apparatus are provided; one set for tensioning the sleeve member material and one set for tensioning the carton or cup body material to ensure correct registration of the two items together.

In one embodiment any or any combination of four registration steps can take place; a) registration of the sleeve member material prior to embossment, b) registration of the carton or cup body material prior to embossment, c) registration of the embossment and/or gluing stage of the sleeve member, d) registration of the carton or cup body material, embossment and/or gluing stage of the carton or cup body material.

The attachment means can include any or any combination of adhesive, welding, heatg sealing and/or the like. In one example the sleeve member blank and the carton or cup body blank are attached or laminated together by passing the same between attachment or lamination rollers. Suitable apparatus for providing or applying the attachment means can be provided.

Curing means can be provided to ensuring curing of the attachment means if required.

Heat sealing means can be provided to ensure sufficient heat and/or pressure is applied to allow heat sealing of the two blanks together if required.

Preferably the sleeve member blank and/or the carton or cup body blank are cut from the elongate web of material using die cutting means, such as for example rotary die cutting apparatus and/or the like.

In one embodiment a single die cutting step can take place once the carton or cup body blank and the sleeve member blank have been joined. For example die cutting means can be provided downstream of the attachment or lamination means in the apparatus.

In one embodiment two separate die cutting steps take place. For example, the sleeve member blank can be die cut from the web material prior to the attachment step and the carton or cup body blank can be die cut before the attachment step or once the sleeve member and carton or cup body have been joined together.

In one embodiment the die cutting means are located in the single line apparatus at suitable positions.

The matrix or skeleton of material surrounding the blanks once the die cutting step has taken place can be removed from the blanks at any suitable point in the apparatus and/or can remain with the attached blanks until such time as is appropriate for its removal when the final cup or carton is formed and erected.

Once the sleeve member blank has been attached to the carton or cup body blank, the laminated blanks can then be further processed to allow forming and/or erection of the carton or cup body in a conventional manner. This can take place in the same single line apparatus of the embossing and attaching apparatus but preferably takes place in separate carton or cup forming apparatus.

The process for forming and erecting the carton or cup body typically includes attaching an edge portion of the carton or cup body blank in overlapping relationship with an opposite edge of the carton or cup body blank and attaching a base to the base end of the carton or cup body. A flange, rolled lip and/or the like can optionally be formed at a top open end of the cup body during this process.

Correct registration of the sleeve member and carton or cup body blanks during the embossing and attaching method typically allows the ends of the sleeve member blank to be brought into abutting relationship when the carton or cup body is formed. Thus, in one embodiment the edges of the carton or cup body blank are attached in overlapping relationship and the edges of the sleeve member blank are in abutting relationship once the carton or cup body is formed and erected.

The adhesive, welding and/or heat sealing via which the two blanks are joined can be provided on a part or parts of the sleeve member blank and/or carton or cup body blank or over substantially the entire surface(s) thereof. In one embodiment the embossed sleeve member blank includes a front surface and a rear surface with one or more or a plurality of embossments or grooves and ridges provided thereon. Preferably at least part of the base of one or more of the rear surfaces of the embossment or grooves are adhered to the exterior or front surface of the carton or cup body blank to allow attachment of the sleeve member blank to the carton or cup body blank.

In one embodiment the embossed carton or cup body blank includes a front surface and a rear surface with one or more embossments or a plurality of grooves and ridges provided thereon. Preferably at least part of an embossment or a top of a ridge is adhered to the rear surface of the sleeve member blank to allow attachment of the sleeve member blank to the carton or cup body blank.

In one embodiment the embossing on the cup or carton body blank includes the formation of protruding means therein. Preferably the protruding means are provided substantially wholly or partially around a circumferential part or perimeter part of the cup or carton body when formed. For example, the protruding means can be provided substantially parallel to an upper and/or lower edge of the cup or carton body blank.

Preferably the embossed protruding means creates location means for the location of a membrane, foil, closure means and/or the like therewith, therebetween or thereon when the cup body is formed/erected. The membrane, foil, closure means and/or the like can be used to retain one or more items, product and/or the like in a compartment formed within the cup body.

The protruding means typically define a shoulder, lip, channel or similar to comprise the location means. Thus, the location means can include single inwardly protruding means, two or more inwardly protruding means provided a spaced distance apart which define a location recess therebetween and/or the like.

The protruding means are typically formed on an inner surface of the cup or carton body blank so as to protrude inwardly of the cup or carton blank when the cup or carton is formed.

Preferably the sleeve member blank and/or the carton or cup body blank is formed from paper, paper board, cup board material and/or the like. The material from which the sleeve member blank and/or the carton or cup body blank is formed from can include heat sealable material or can include one or more heat sealable coatings provided thereon. For example, the heat sealable material or coating can include a polyethylene terephtalate (PET) coating and/or any other suitable heat sealable material which has adhesive properties when heat and/or pressure is applied thereto.

Preferably the sleeve member has a top edge, a base edge and two end edges. The top edge typically faces towards or is adjacent the top open edge of the cup when joined. The base edge typically faces towards or is adjacent the base of the cup when joined. The two end edges are typically in abutting relationship when the cup is formed.

The sleeve member can be designed, shaped and/or sized to cover substantially the entire outer surface of the carton or cup body side walls or can cover one or more parts thereof.

Preferably the sleeve member and/or carton or cup body is in the shape of a frustum of a cone when formed and erect. The carton or cup body and/or sleeve member blanks typically have an upper convex or curved edge and a lower concave or curved edge. Preferably substantially linear ends join the upper and lower edges together.

Preferably the sleeve member blank is substantially complementary in shape to the carton or cup body blank. The sleeve member blank is preferably substantially equal to or of smaller dimensions than the carton or cup body blank.

Preferably an end edge of the sleeve member blank is substantially aligned with or is substantially flush with the end edge of the carton or cup body blank when the registration means are aligned. The opposite end edge of the sleeve member blank and the opposite end of the carton or cup body blank are preferably a spaced distance apart, thereby providing a margin adjacent the ends which is preferably running longitudinally of the carton or cup or along the height of the carton or cup which is free of sleeve member material. This margin is typically brought into overlapping relationship with an inner surface of the carton or cup body when the carton or cup is formed. It also allows the end edges of the sleeve member to abut each other when the carton or cup is formed.

In one embodiment an upper edge of the sleeve member blank is provided a spaced distance apart and further preferably is below the upper edge of the carton or cup body blank. This provides a margin of the carton or cup body free from sleeve member which can be used to form a suitable lip or flange for the carton or cup.

In one embodiment a lower edge of the sleeve member blank is provided a spaced distance apart from and further preferably below the lower edge of the cup or carton body blank. This provides a margin of the carton or cup body free from the sleeve member which can be used to form or help form a base of the carton or cup.

Preferably the apparatus for embossing and laminating the sleeve member and/or carton or cup body is automated electronic apparatus. Preferably the apparatus has a single electronic line shaft allowing independent and separate control of one or more motors used to drive the apparatus.

According to a second aspect of the present invention there is provided a cup, said cup comprising a cup body having side walls, a first closed end located at a base of the cup body, a second open end located at a top of the cup body and a sleeve member located on at least part of the exterior surface of the cup body side walls, the sleeve member comprising at least one embossed layer which is attached to the exterior side walls of the cup body prior to forming and/or erecting the cup body.

According to a third aspect of the present invention there is provided a cup, said cup comprising a cup body having side walls, a first closed end located at a base of the cup body, a second open end located at a top of the cup body and a sleeve member located on at least part of the exterior surface of the cup body side walls, the cup body comprising at least one embossed layer or surface which is attached to a rear side of the sleeve member prior to forming and/or erecting the cup body.

Preferably the sleeve member has first and second ends which abut each other.

Preferably the cup body has first and second ends which are attached in overlapping relationship with each other.

Preferably the at least one embossed layer is a single layer or multi-ply layer of embossed material. Preferably the embossed layer or layers are joined directly to the cup body and/or sleeve member.

According to further independent aspects of the present invention there is provided a container in the shape of a frustum of a cone; a method of forming a container in the shape of a frustum of a cone; embossing and attachment apparatus for embossing a sleeve member and attaching the sleeve member to a cup body.

In one aspect of the present invention the method includes forming a carton or cup from a carton or cup body blank, locating the carton or cup body blank in registration with embossing means to allow embossing of the carton or cup body blank in a pre-determined position prior to forming and/or erecting the cup into a required erect cup shape. In this aspect, it is not necessary for the carton or cup to have an outer sleeve member associated with the same.

Embodiments of the present invention will now be described with reference to the accompanying figures, wherein:

FIG. 1a is a front view of the embossed sleeve member blank attached to the cup body blank prior to forming and erecting the cup in one embodiment of the present invention;

FIG. 1b is an end view of the blanks in FIG. 1a;

FIG. 1c is a perspective view of the cup formed from the erected blanks in FIG. 1a;

FIG. 2a is a simplified view of the embossing and attachment apparatus used to emboss a sleeve member blank and bring the same into correct registration with the cup body blank for attachment in one embodiment;

FIG. 2b is a simplified view of the embossing and attachment apparatus used to emboss a cup body blank and bring the same into correct registration with the sleeve member blank for attachment in one embodiment;

FIG. 3 is a simplified view of the apparatus shown in FIG. 2 according to a further embodiment;

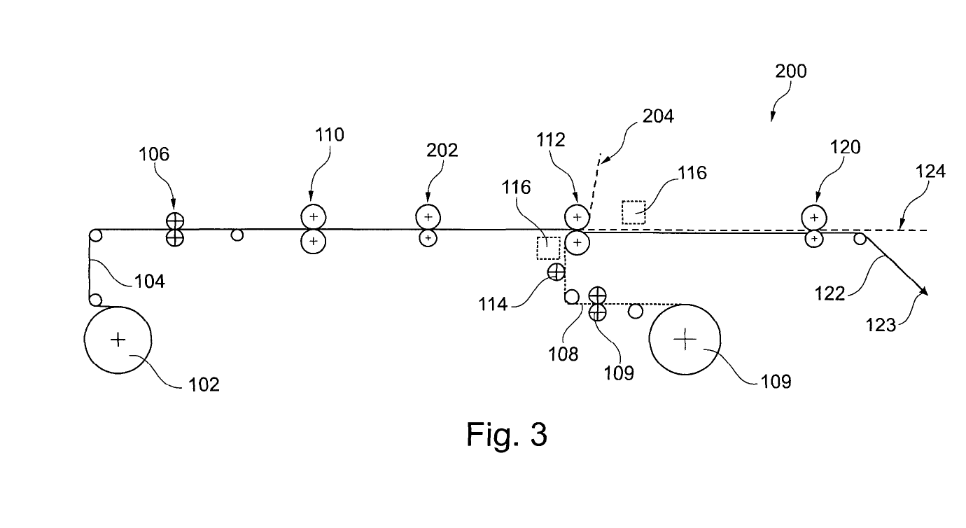

FIG. 4 is a simplified view of the web materials from which the sleeve member blank and cup body blank are formed when in registration prior to final removal of the cup paper matrix surrounding the die cut paper blank;

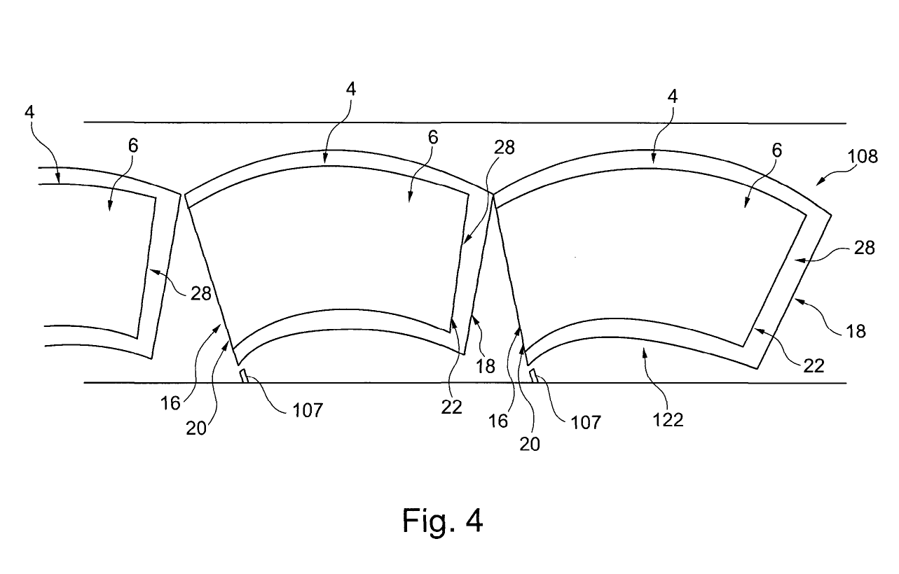

FIG. 5a is a front view of the sleeve member blank attached to an embossed cup body blank prior to forming and erecting the cup in one embodiment of the present invention;

FIG. 5b is an end view of the blanks in FIG. 5a;

FIG. 5c is a perspective view of the cup formed from the erected blanks in FIG. 5a;

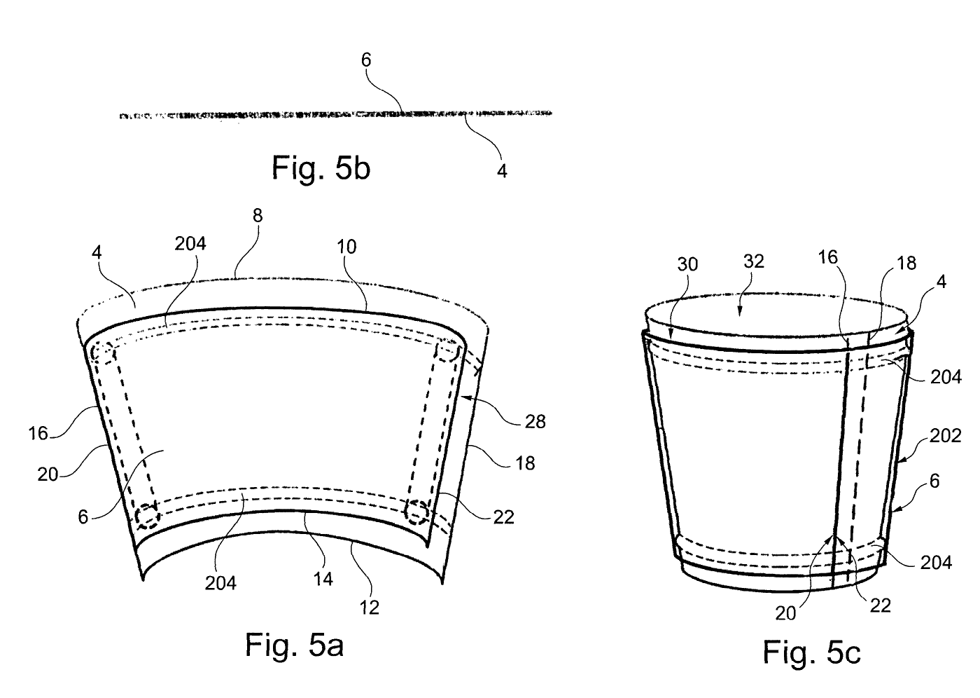

FIG. 6 is a simplified view of embossing apparatus used to emboss a cup body blank prior to erection of the cup body blank to form a cup in one embodiment;

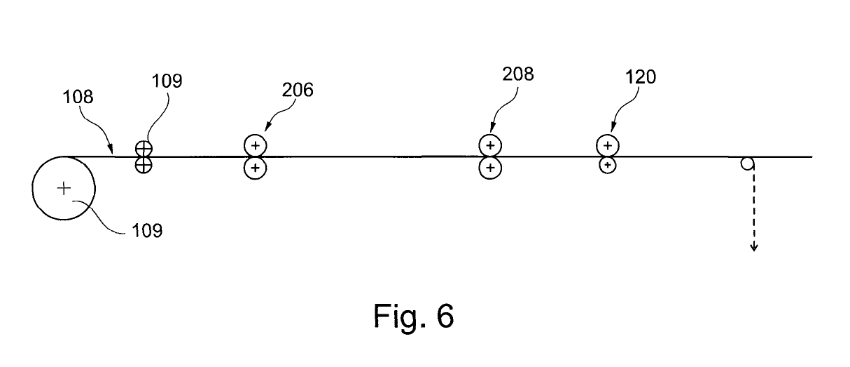

FIG. 7a is a plan view of the inner surface of a cup body blank prior to erection into a cup body in one embodiment;

FIG. 7b is an end view of the cup body blank and the sleeve member blank when joined in the embodiment in FIG. 7a; and

FIG. 7c is a perspective view of the cup formed from the erected blanks shown in FIGS. 7a and 7b.

Referring initially to FIGS. 1a-1c, there is illustrated a container in the shape of cup 2 formed from a cup body blank 4 and a sleeve member blank 6 according to an embodiment of the present invention.

The cup body blank 4 in this example is formed from PET coated cup board material which can include a single layer of cup board material or can be a laminate paper or board material. The sleeve member blank 6 is formed from a single layer of embossed paper or paper board material. In the illustration the embossments are shown as spaced apart dotted lines 7. It will be appreciated the embossments can be provided in any number, shape and/or design as required.

Both the cup body 4 and sleeve member 6 in this embodiment have the shape of a frustum of a cone, each having a convex upper edge 8, 10 respectively, and a concave lower edge 12, 14 respectively. Cup body blank 4 has end edges 16, 18 respectively and sleeve member blank 6 has end edges 20, 22 respectively.

Thus, the cup body blank 4 and sleeve member blank 6 are of substantially complementary shape but sleeve member blank 6 is of smaller dimensions than cup body blank 4 so that edges 10, 14 and 22 of the sleeve member blank are located within and a spaced distance apart from edges 8, 12, 18 of cup body blank 4.

It is to be noted that edge 20 of sleeve member blank 6 is in registration, alignment or is flush with edge 16 of cup body blank 4. This registration or alignment process takes place just prior to or during attachment of the blanks together, as will be described in more detail below.

The rear surface of sleeve member blank 6 is glued to the top surface of cup body blank 4 via adhesive along lines 24, 26. However, it will be appreciated that any suitable pattern or location of adhesive can be used to attach the blanks 4, 6 together as required.

In forming the cup, edge 18 of cup body blank 4 is moved towards edge 16. The sleeve free margin 28 of the front surface of the cup body blank adjacent edge 18 is heat sealed to the rear surface of the cup body blank adjacent edge 16 using suitable application of heat and pressure to maintain edges 16 and 18 in overlapping relationship. Edge 20 is brought into abutting (non-overlapping relationship with edge 22). This provides the external sleeve of the cup with an improved aesthetic appearance and is a result of edges 16, 20 being in correct registration with each other when the blanks are located together.

The sleeve free margin or space 30 between upper edge 8 and upper edge 10 of the blanks 4, 6 can be rolled to form a lip (not shown) to define a neat edge for the open end 32 of the formed cup 2. The sleeve free margin or space 34 between lower edge 12 and lower edge 14 of the blanks 4, 6 can be folded inwardly of the cup for attachment to a base member to form the base (not shown) of the cup if required. Alternatively, a base member can be inserted internally or externally of the cup and attached in any suitable manner as required.

It is to be noted that the sleeve blank 6 shown in FIGS. 1a-1c preferably has an embossed pattern on a surface thereof in accordance with the present invention.

Referring to FIG. 2a, there is illustrated a method of embossing the sleeve member blank 6 and laminating the sleeve member blank 6 with the cup body blank 4 in correct registration using apparatus 100.

The apparatus includes a first feed roller 102 on which an elongate web of sleeve forming paper 104 is wound. The paper web is typically pre-printed with any suitable printing matter, logo, pattern and/or design thereon. The paper 104 is unwound and fed from the feed roller 102 towards tensioning means. The unwind mechanism in one example is a braked unwind with lateral web guidance and loadcell feedback tension control. The tensioning means include a pair of rollers called a tension nip 106 which provide sufficient tension to the paper web to allow correct alignment and registration of the paper 104 with an elongate web of cup forming paper 108 downstream of tension nip 106, as will be described in more detail below. It also allows correct alignment and regulation of the pre-printed matter on the paper 104 with an embossment to be located thereon and/or gluing step.

With sleeve forming paper 104 at the correct tension, it then undergoes an embossing step using embossing means. Paper 104 is fed between a pair of embossment rollers 110 to allow a suitable pattern, design, one or more grooves, ridges, corrugations and/or the like to be embossed onto the sleeve paper at a suitable position thereon. The position of the embossment forming portion on each roller is such that the embossment forming portions match when the rollers are rotated through a suitable angle of rotation. However, it is noted that any suitable embossment means could be used.

Cup forming paper 108 is wound onto a further roller 109 and is fed and unwound in the apparatus towards laminating means in the form of laminating rollers 112. The unwind mechanism in one example is a braked unwind with loadcell feedback. Lateral web guidance can be indicated if required. Attachment means in the form of glue is applied at a gluing station 114 on a front surface of cup paper 108 in a suitable pattern or arrangement so that paper 108 is glued to sleeve forming paper 104 when paper webs 104 and 108 are brought into registration with each other and pass through laminating rollers 112. The tension created by tension nip 106 is such that sleeve forming paper 104 is brought into correct alignment and registration with cup paper 108 prior to entering laminating rollers 112. However, an additional tension nip 107 or other suitable register adjustment device can be provided between the unwind mechanism of the cup forming paper 108 and the gluing stage 114 or lamination stage 112. This is typically used, but not necessarily exclusively, if the cup material is pre-printed.

The tensioning nips 106, 109 can be provided with loadcell feedback if required.

Correct registration and alignment of the two blanks 4, 6 is achieved using registration means in the form of printed registration marks 107 provided at spaced apart intervals on the paper webs 104, 108 at positions typically located outside of or surrounding the blank forming parts 4, 6. Detection of correct alignment of the registration marks can be undertaken using conventional technology, such as for example using image analysis. If misalignment of the registration marks of the paper webs or blanks is identified, the tension in the tension nip can be adjusted accordingly to allow the tension of sleeve member to be changed to allow correct alignment of the registration marks.

Depending on the glue technology used at gluing station 114, it may be necessary to include glue curing station 116 either upstream or downstream of the laminating rollers 112, as shown by dotted lines on FIGS. 2 and 3. The glue curing station 116 can include infra-red (IR) curing means in one example but other suitable curing means could be used.

The laminated paper web 118, comprising the adhered and registered sleeve member paper and cup body paper, is then fed into cutting means in the form of die cutting apparatus, which in this example is a pair of rotary die cutting rollers 120. The die cutting rollers cut the appropriate sleeve member blank and cup body blank shapes as shown in FIG. 1a. The excess paper web material or scrap matrix 122 can then be removed by suitable means, such as using a drive roller, for disposal in a bin, scrap, recycle or chop system, as represented by arrow 123. The cut and laminated cup and sleeve blanks 124 is then passed for collation or fed to a cup forming machine to form and erect the cup shown in FIG. 1c.

The rollers of the apparatus are typically controlled and driven by an electronic drive shaft using conventional technology. For example, each roller can be driven by its own independently controlled motor and drive system. It allows independent control of each of the rollers, feeds, stations and/or the like of the apparatus. For example, the speed of each roller can be independently controlled. Micro-processing means are typically provided to allow control of the electronic drive shaft technology and to process data measured and/or received at one or more locations of the apparatus to allow feedback control at one or more other locations of the apparatus. For example, detection of alignment of the registration means using suitable detection means located at the point of lamination of the sleeve member paper and the cup body paper allows feedback control of the tension generated in the sleeve member paper by tension nip 106 using the micro-processing means.

FIG. 2b shows the apparatus used to emboss the cup body blank 4 and bring the embossed cup body blank material into correct registration with sleeve member blank 6. The method and apparatus is similar to that shown in FIG. 2a but embossment means in the form of embossment nip 206 is provided between tensioning nip 109 and the laminating rollers 112 to allow cup forming paper 108 to be embossed prior to being joined with the sleeve forming paper 104. Embossment means in the form of embossment rollers 110 are not required between the tensioning nip 106 and laminating rollers 112 to allow sleeve forming paper 104 to be embossed.

The gluing station 114 is also typically moved from the cup forming part of the apparatus to the sleeve forming part of the apparatus in FIG. 2b compared to the embodiment described in FIG. 2a. Thus, gluing station 114 is provided between tensioning means 106 and laminating means 112 in the sleeve forming part of the apparatus in FIG. 2b.

The sleeve member and/or the cup body can be pre-printed with suitable printed matter thereon if required.

A second embodiment of the cup and sleeve embossing and lamination apparatus 200 is shown in FIG. 3. However, in this embodiment, the sleeve member blank is die cut using cutting means in the form of die cut rollers 202 located upstream of lamination rollers 112 (i.e. prior to lamination and registration with cup paper 108) and downstream of embossment rollers 110. The first die cut process taking place at rollers 202 and typically leaves the embossed sleeve member blanks partially connected to the surrounding paper web or matrix before being joined to paper web 108 and fed through laminating rollers 112. The paper web or matrix 204 surrounding the die cut sleeve member blank can optionally be removed at or just downstream of laminating rollers 112. Alternatively, the surrounding paper web or matrix 122 of both the cup blank and the sleeve member blank or the cup blank alone is removed for disposal or otherwise as shown by arrow 123 after the second die cut process 120.

Removal of the paper web or matrix surrounding the die cut paper and/or cup blanks directly after the die cut process 202 and/or 120 is optional since in some applications it may be advantageous to leave the matrix skeleton attached to the blanks to allow easier collation and winding of the same onto a suitable roller prior to forming and erecting the cups using suitable cup forming apparatus.

The advantage of the second described embodiment, in which the sleeve member blank is die cut upstream of the lamination process, is that it prevents possible damage to the cup body blank which may result in the first described embodiment wherein the sleeve member blank and cup body blank are die cut at the same time using single die cutting means.

In a preferred embodiment the sleeve member is embossed with corrugations (plurality of grooves or ridges), the length of which run in the direction of the longitudinal axis or height of the cup (i.e. between the base and top open end of the cup). The corrugations can be substantially parallel corrugations, linear corrugations, wavy lines and/or the like. The rear surface of the base of the grooves are typically in direct contact with the outer surface of the cup body when the blanks are laminated together. The air gaps in the grooves between the ridges provide insulation for a user gripping the sleeve member when the cup is formed if any hot liquid is located in the cup.

An advantage of the present invention is that by embossing a single sleeve member layer (or sleeve member layer(s) which do not have a backing or intermediate layer) in place of using conventional corrugated paper, the need for corrugation apparatus is removed. This allows the embossing and lamination apparatus to be made significantly smaller than with prior art corrugation apparatus. For example, conventional corrugation apparatus is typically 1.6 m wide, whereas the apparatus of the present invention is typically one cup wide or 300 mm wide in one example, thereby significantly saving space and expense. Since the apparatus is smaller, it also allows more detailed embossment designs to be located on the sleeve member material being fed through the apparatus. In addition, the speed at which the blanks can be processed in the present invention is significantly quicker than with conventional apparatus. For example, the apparatus of the present invention could feed paper web therethrough at 100 metres/minute, thereby allowing 500 cup blanks/minute to be produced. Since the embossed layer or layers of the sleeve member do not require an intermediate layer to hold the embossments together or to provide a surface via which the embossment layer(s) can be fixed to the outer surface of the cup body, this results in less material being required, thereby saving cost of the final cup design.

Referring to FIGS. 5a-5c, there is illustrated a cup 202 according to a further embodiment of the present invention. The cup 202 is similar in design to the cup 2 shown in FIGS. 1a-1c but the cup body blank 4 is provided with embossments 204 thereon (shown by dotted lines) and there is no embossment provided on sleeve member blank 6. The cup 202 is erected in a similar manner to the cup 2 described in FIGS. 1a-1c and the same features are have been referenced using the same reference numerals.

In the illustrations, the embossments 204 are shown as ridges, each ridge defined between two dotted lines which run parallel to the upper edge 8 of cup material 4 and the lower edge 12 of cup material 4. The ridges allow an air gap to be created between the out surface of the cup body material 4 and the sleeve material 6 to act as insulation means as previously described. It will be appreciated that the embossments 204 can be provided in any suitable shape, size, number and/or design as required.

In this embodiment the sleeve member 6 can be pre-printed with a suitable design, logo, image and/or the like if required.

FIG. 6 illustrates a yet further embodiment of the present invention wherein the cup body material is tensioned using tension nip 109 and embossed using embossment nip 206 but there is no requirement for an outer sleeve member to be provided therewith. As such, no lamination procedure or means are required. Drive means in the form of drive nip 208 can optionally be provided if required to move the cup body material 108 towards the die cut 120. Registration means are still typically required on the cup body material to ensure the cup body material is embossed in a pre-determined location, particularly if the cup body material is pre-printed and the embossment is required to be in a particular location relative to the pre-printed matter.

FIGS. 7a-7c illustrate an embodiment of the present invention wherein the cup body material 300 is embossed in the manner described above to form an embossed area suitable for the location of a detachable membrane or closure therewith. This allows a closed sub-compartment 302 to be formed within the cup for the location of product, such as for example coffee granules, tea, hot chocolate powder and/or the like. In use, the detachable membrane or closure can be removed and hot water can be added to the product contained within the cup body sub-compartment 302.

More specifically, the embossed area includes two inwardly, spaced apart and substantially parallel protruding lips 304, 306 formed on an inner surface of cup body material 300. Lips 304, 306 define a location recess 308 therebetween. A detachable membrane 310 can be located, adhered and/or engaged in the location recess 308 when the cup is erected and this membrane can act as a closure to retain product provided in a lower part or sub-compartment 302 of the erect cup.

The detachable membrane can be in any suitable form, such as a plastic cover, foil, paper, board material and/or the like so as to act as a closure for one or more items located in sub-compartment 302.

The embossed area can also include any or any combination of suitable forms of embossment sufficient to define location means for location of a closure therewith.

Although the embossed area is shown around a peripheral surface of the cup body blank midway between a top edge 312 and a base edge 314 of the cup blank, it will be appreciated that the embossed area can be provided at any suitable position on the cup body blank 300 and can be provided in any suitable size, shape and/or number.

The sleeve member blank 6 can be joined to the cup body blank 300 as previously described. The embossed area can be in addition to or as an alternative to embossing used to create one or more insulating air gaps between the cup body and the sleeve member.

1. A method of forming a carton including a sleeve member, said method including the steps of locating a sleeve member blank in registration with a carton body blank in a pre-determined position, and attaching an inner surface of the sleeve member blank to an external surface of the carton body blank prior to forming and/or erecting the attached carton and sleeve blanks into a required erect carton shape.

2. A method according to claim 1 wherein the carton is in the form of a cup.

3. A method according to claim 1 wherein the method includes the step of embossing the sleeve member blank and/or the carton body blank using embossing means.

4. A method according to claim 3 wherein the embossing step takes place before attachment of the sleeve member blank to the carton body blank.

5. A method according to claim 3 wherein the embossing step includes the location of or formation of any or any combination of one or more ridges, grooves, corrugations, logos, patterns, profiles, designs, images, shapes, letters, numerals, protrusions, in the sleeve member blank and/or the carton body blank, to form an air gap or location means for the location of a foil, closure means, membrane and/or other item.

6. A method according to claim 5 wherein the method step of locating a foil, closure means, membrane and/or other item with the embossment on the carton creates a closed compartment or sub-compartment in the carton to allow one or more items or product to be retained therein.

7. A method according to claim 1 wherein the material from which the sleeve member blank and/or carton body blank is formed is a single layer of material.

8. A method according to claim 1 wherein the material from which the sleeve member blank and/or carton body blank is formed is a laminate or multi-ply material.

9. A method according to claim 3 wherein the embossment step of the sleeve member blank and/or carton body blank and the attachment step of the sleeve member blank with the carton body blank takes place in a single line apparatus or includes apparatus having a single electronic line shaft to allow independent and separate control of one or more motors used to drive the apparatus.

10. A method according to claim 1 wherein registration means are associated with the carton body blank, the sleeve member blank and/or an elongate web of material from which the carton body blank and/or sleeve member blank are formed to allow the carton body blank and the sleeve member blank to be brought into registration or correct alignment together prior to and/or during attachment of the blanks together.

11. A method according to claim 10 wherein the registration means includes any or any combination of a mark, cut or indication means.

12. A method according to claim 10 wherein the registration means are substantially hidden from view when the final carton is formed, are provided on a seam or edge of the carton or sleeve member and/or are provided in the web material surrounding the carton body blank and/or the sleeve member blank.

13. A method according to claim 10 wherein detection means are provided to detect the registration means.

14. A method according to claim 1 wherein the sleeve member blank and/or the carton body blank are formed from elongate webs of material and the blanks are attached together either before or after the blanks are cut from the elongate webs of material.

15. A method according to claim 14 wherein the elongate webs of material are fed into carton forming apparatus using a feed roller or a braked unwind roller.

16. A method according to claim 10 wherein registration apparatus is used to bring the registration means of the sleeve member blank and/or the carton body blank into registration and said registration apparatus is or includes tensioning means.

17. A method according to claim 16 wherein the tensioning means is in the form of a tensioning nip, roller or rollers.

18. A method according to claim 3 wherein embossment means and attachment means used on the carton body blank and/or the sleeve member blank are operated together in substantial synchrony.

19. A method according to claim 16 wherein any or any combination of four registration step take place; a) registration of the sleeve member material prior to embossment, b) registration of the carton body material prior to embossment, c) registration of the embossment and/or gluing stage of the sleeve member, d) registration of the carton body material, embossment and/or gluing stage of the carton body material.

20. A method according to claim 1 wherein the carton body blank and the sleeve member blank are attached together via any or any combination of adhesive, welding or heat sealing.

21. A method according to claim 14 wherein the blanks are cut using die cutting apparatus.

22. A method according to claim 1 wherein the method for forming and erecting the carton includes moving end edges of the sleeve member blank in abutting relationship and moving end edges of the carton member blank in overlapping relationship.

23. A method according to claim 1 wherein a rear surface of one or more embossments provided on the sleeve member blank is adhered to the exterior or front surface of the carton body blank, and/or a front surface of a carton body blank with one or more embossments provided thereon is adhered to a rear surface of the sleeve member blank.

24. A method according to claim 1 wherein the sleeve member and/or carton body is in the shape of a frustum of a cone when formed and erect, the carton body and/or sleeve member blanks typically include an upper convex or curved edge and a lower concave or curved edge.

25. A method according to claim 1 wherein the sleeve member blank is substantially complementary in shape to the carton body blank and is of substantially equal or smaller dimensions than the carton body blank.

26. A method according to claim 1 wherein an end edge of the sleeve member blank is substantially aligned with or is substantially flush with an end edge of the carton body blank when the registration means are aligned and an opposite end edge of the sleeve member blank and an opposite end of the carton body blank are a spaced distance apart to provide a margin adjacent the ends which is free of sleeve member material.

27. A method according to claim 1 wherein an upper edge of the sleeve member blank is provided a spaced distance apart from the upper edge of the carton body blank to provide a margin free from sleeve member material.

28. A method according to claim 1 wherein a lower edge of the sleeve member blank is provided a spaced distance apart from a lower edge of the carton body blank to provide a margin free from sleeve member material.

29. A carton formed according to the method in claim 1.

30. A carton according to claim 29 wherein said carton is in the form of a cup.
